(19) United States
(12) Patent Application Publication
(10) Pub. No.: US 2012/0253952 A1
(43) Pub. Date: Oct. 4, 2012

(54) Method for a plurality of online digital video commercials on a consecutive printing pattern applied during digital music file downloading over internet

(76) Inventor: Jean Pierre RAFENOMANJATO, Quebec (CA)

(21) Appl. No.: 13/077,643

(22) Filed: Mar. 31, 2011

(51) Int. Cl. G06Q 30/00

(52) U.S. Cl. 705/14.73

(57) ABSTRACT

A method using TV advertising principles with some interactivity improvements, applied to the internet network domain is used to sponsor a free digital music file download by generating a sufficient amount of money which enables paying all royalties which are constituted by mechanical royalties, production royalties and recording artist royalties, giving the user a complete personal non-commercial license for the use of the digital music files he has just acquired; this process is made possible by using an algorithm to calculate the number of ads required, a process of selection of ads depending on different factors with different weighting but not limited to geographical location, event related, cyclic, targeted audience, special request; controlling the download process by either a slowdown or splitting process, so the complete file is obtained only after the viewing of all ads which is achieved by using a proprietary media player. This method is made possible through the support of a central internet server which includes a song database, advertising database, user database, data concerning standard copyright or specific contract-based copyright, a formula for the calculation of the number of adds required, automatic selection of advertising, and accounting process. This central database has the possibility of linking to external databases from outside partners to obtain songs or advertising, and to link to the computerized unit of the user through the internet network.

### CROSS-REFERENCE TO RELATED APPLICATIONS

Related Application No. 1: Fampat family
   US2008270623 A1 20081030 [US20080270623]
   STG: First published patent application
   AP: 2006US-0089750 20061115
   FD: PCT/US06/44400 20061115 [2006WO-US44400]
   FD: Provisional: U.S. 60/739,811-20051123[2005US-P739811]
Related Application No. 2: Fampat family
   US2007198660 A1 20070823 [US20070198660]
   STG: First published patent application
   AP: 2007US-0676662 20070220
   FD: Provisional: U.S. 60/775,214-20060221[2006US-P775214]
Related application No. 3: Fampat family
   KR20010046018 A 20010605 [KR20010046018]
   STG: Unexamined patent application
   AP: 1999KR-0049585 19991110
Related application No. 4: Fampat family
   KR20010089031 A 20010929 [KR20010089031]
   STG: Unexamined patent application
   AP: 2000KR-0014127 20000320
Related application No. 5: Fampat family
   KR20010076505 A 20010816 [KR20010076505]
   STG: Unexamined patent application
   AP: 2000KR-0003691 20000126
Related application No. 6: Fampat family
   KR20010047990 A 20010615 [KR20010047990]
   STG: Unexamined patent application
   AP: 1999KR-0052446 19991124
Related application No. 7: Fampat Family
   KR20010008019 A 20010205 [KR20010008019]
   STG: Unexamined patent application
   AP: 2000KR-0065087 20001102
Related application No. 8: Fampat Family
   KR20000006853 A 20000207 [KR20000006853]
   STG: Official gazette of the unexamined patents
   AP: 1999KR-0049291 19991108
Related Application No. 9: Fampat family
   FR2870952 A 1 20051202 [FR2870952]
   STG: Application, first publication
   AP: 2004FR-0005637 20040525
   WO2005119537 A1 20051215 [WO2005119537]
   STG: Publ. Of in Appl. With int. Search rep
   AP: 2005WO-FR50363 20050525
   EP1754189 A1 20070221 [EP1754189]
   STG: Public. Of applic. With search report
   AP: 2005EP-0766690 20050525
   CN1989522 A 20070627 [CN1989522]
   STG: Unexamined application for a patent for inv.
   AP: 2005CN-80025107 20050525
   FR2870952 B1 20071019 [FR2870952]
   STG: patent of invention (2nd publication)
   US2008209060 A1 20080828 [US20080209060]
   STG: First published patent application.
   AP: 2007US-0597293 20071031
   FD: PCT/FR2005/050363 20050525 [2005WO-FR05036]
Related application No. 10: Fampat family
   JP2003076912 A 20030314 [JP2003076912]
   STG: Doc. Laid open to publ. Inspec.
   AP: 2001JP-0269490 20010905

### BACKGROUND

This invention relates to music file downloading over internet by means of standard computer or computerized units. More and more people have access to a computer, and internet access is spreading even more with faster and faster connection speeds, and an increasingly larger variety of devices of all sorts as well as mobile devices, are able to playback music. These three factors allow people to easily exchange and copy digital music files without any loss of quality. This situation causes a new problem, which is the illegal downloading (or sharing) of music files, meaning without compensating the copyright owners, artists and record companies, which is still a problem since several years, and despite thousands of lawsuits against companies and individuals, this problem still persists. Therefore, the industry has to find a practical and universal way of doing business to make music files available free of charge over the internet and compensate copyright owners.

### PRIOR ARTS

Both Application Nos. US2008270623 and KR20010046018 are offering music online services and inserting advertising among a music playlist comprising some differences between the two methods. This type of solution requires that when you want to listen to your music, you have to be connected to internet, the advertisement pattern is not well defined within those applications. It's not so critical essentially due to the fact that the amount required to be paid to digital rights owners is quite low, such as approximately $0.015, so any kind of advertisement rating at 15 CPM will be suitable for this purpose. With those types of methods, a person just listens to the music online, but never owns it.

Applications No.: KR20010089031, No.: KR20010076505, No.: KR20010047990, No.: KR20010008019, No.: KR20000006853, No.: US2007198660 are different processes for downloading music files, and they can be grouped together due to the fact that they are using related technologies based on inserting information which can be advertising within the music files. In this type of process, the user get a file which contains an advertisement, so each time the user wants to play the music, he has to see or listen to the ads before or during the playback of the song. In some the cases with a specific digital media player connected to a central database managed by internet, the need to play the ads ceases after a certain number of playbacks of those ads.

In the specific case of application No: FR2870952 (US2008209060): line 15 fr ( . . . an ad is posted . . . ) line 35, it is mentioned that one advertisement is played using a streaming process during the download process, the user has to watch this advertisement before being able to play the music file, which is encoded and saved on a proprietary format in the user computer, and requires a proprietary player including a specific plugging. The file contains an offline version, afterwards, when playing the file, if the user is not connected to internet, the offline version of the ad is played. In other cases of connections, the ad is streamed and played from the server. After viewing the ad a certain number of times, the user is allowed to save the file on a standard format such as MP3 or similar media. In this type of process, it's obvious that streaming one advertisement during the download process won't generate enough money to support all required amounts, such as royalties etc. . . . . This way of doing things forces the process to send a polluted file which may include lighter ads within the musical file itself or a remote call for the original ads. Each time the user wants to play this file later on, he has to watch the ad before. The user won't be able to copy and play this file on a casual MP3 player or other devices and another computer where the proprietary plugging is not installed, not even being able to burn the file on a CD. This can be done only after a certain amount of time.

In Application No.: JP2003076912, the advertising is just mentioned as a process to be able to generate money to avoid illegal downloading. In order to reach a certain level of income that makes a project commercially viable, the advertising principle needs more research than just mentioning: “we display ads” . . . . A more realistic, practical and financially-sound way of doing business has to be found.

### SUMMARY

An improved way of reducing the illegal downloading of music and of satisfying the needs of ever increasing numbers of people to get music free of charge can be achieved by applying TV advertising principles to internet. Practically speaking we exchange their time spent on watching approximately three-minute of ads to be granted rights for personal use for one song, and it happens when the consumer is obtaining the song file by a specific downloading process. The advertising pattern could be 6 videos of thirty seconds or nine videos of twenty seconds, or any pattern that meets financial requirements. The time required to download an MP3 file is far less that the allocated advertising time slot so in order to oblige the user to watch all the ads, this is what the process is like: for explanation purposes let's say that for one song, the algorithm decides to display six different ads. Before downloading, the music file is split into six parts. The downloading process and the advertising viewing will process in parallel, as follows. The first ad is initiated by a click to start downloading; the media player of the ads makes a pause at the end of each ad and displays an arrow to click in order to start the next ad. Each click will start the download of the next portion of the song. At the end of the last ad, the user is invited to make a last click to obtain the certificate of personal use rights granted for the song; this operation will start the re-assembly of the song in parallel to produce a standard MP3 or WAV file.

After this process is completed the user is granted a full personal use rights for the digital content for this song, he can copy and play it on all his standard audio devices, he can burn it on a CD or use it otherwise for personal purposes and uses.

### DRAWINGS

FIG. 1 is a perspective view of the first embodiment of the invention

FIG. 2 is a detail of the portion indicated as section A in FIG. 1

FIG. 3 is the detail of section 7 and 8 of FIG. 1

### REFERENCE NUMBERS

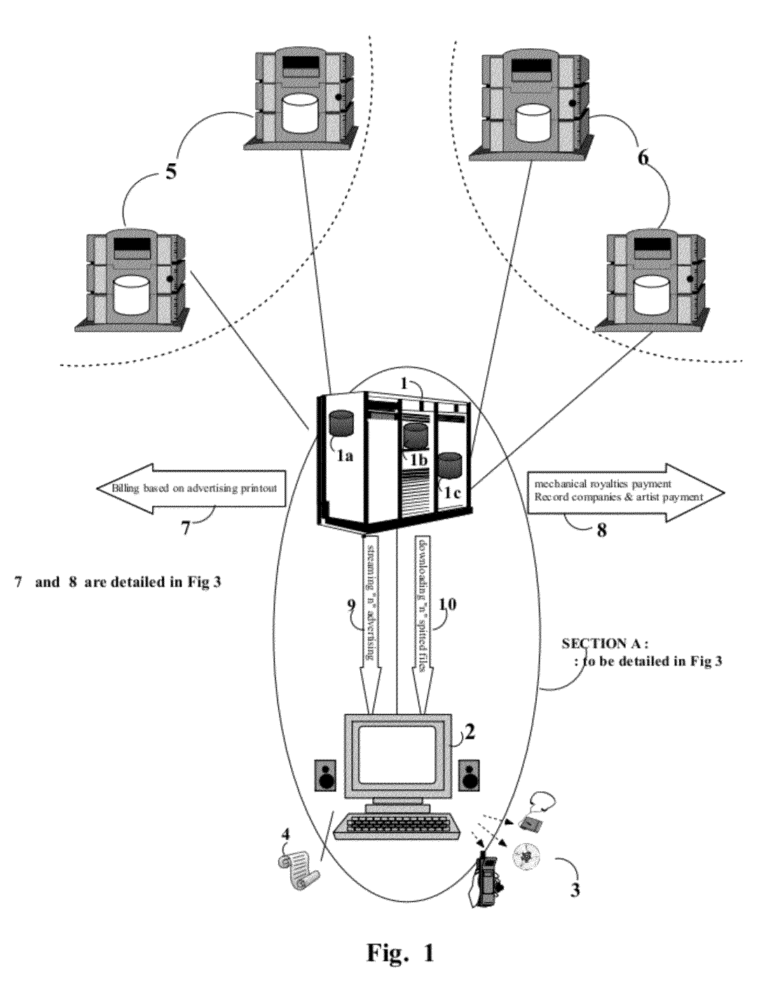

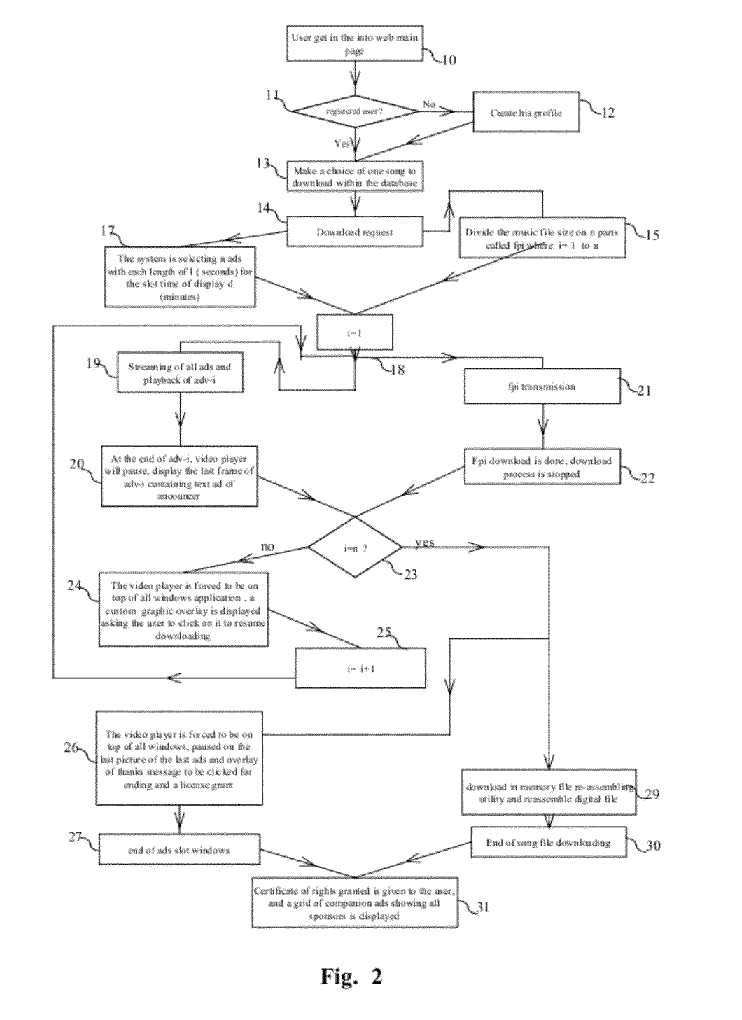

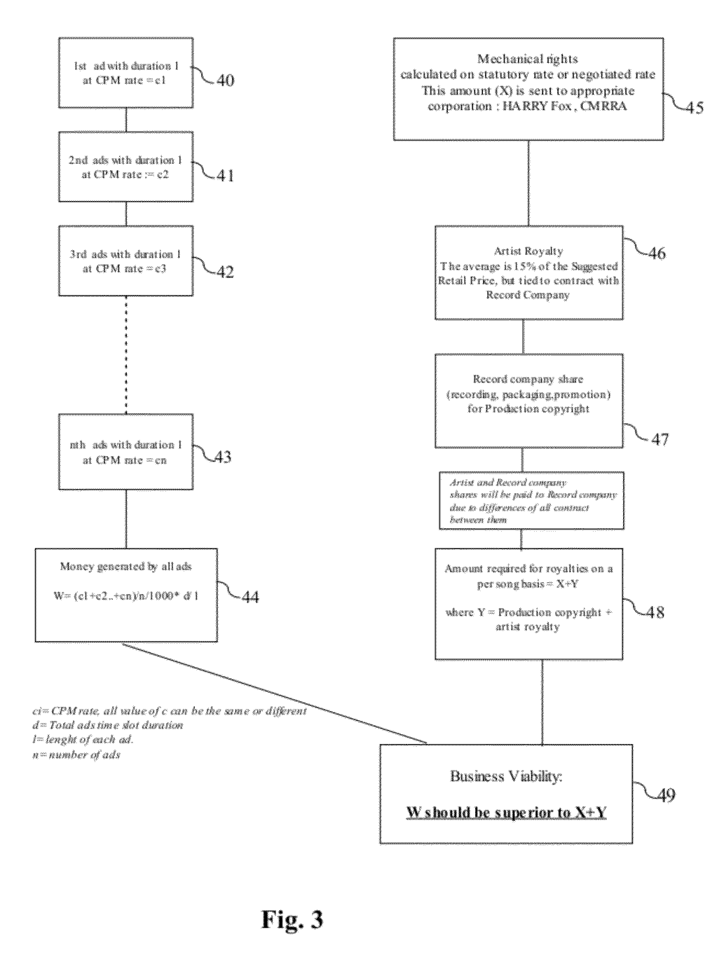

FIG. 1
   1 Main web server which is connected to the end users
      a. 1a is the local advertising database included within the server 1
      b. 1b is the operation management server and the users' and partners' database included within the server 1
      c. 1c is a local song database included within the server 1
   2 The end user computer
   3 Peripheral digital media devices that belong to the end users.
   4 The certificate of Rights granted to the end users for a song.
   5 Outside partner song sources databases
   6 Outside advertising agency ad servers.
   7 Process of generating money
   8 Process of paying royalties owners.
FIG. 2
   From 10 to 31 detailed process flow charts for online digital video streaming and file downloading
FIG. 3
   From 40 to 49: the base of the business advertising pattern required and the money owing.

### DETAILED DESCRIPTION OF FIRST EMBODIMENT

In order to make explanations easier to understand, the following description shall be limited to the core distinction of this invention. We will not explain the communications protocol within the computer server, using internet protocol which is of general knowledge

FIG. 1: is a perspective overall view of the first embodiment. It shows the central server 1 which is the central and operations management, the group of agencies ad servers 5 are existing ad servers which belong to advertising agencies and contain advertising from different announcers under contract. Those servers supply advertising on request through the central server 1. The outside partner songs sources databases are existing song databases from companies which may be recording companies or song wholesalers; they provide songs on request and data related to those songs. In some cases when wholesalers are under contract, they handle all copyright management themselves. The personal computer 2 is the end user. From this computer, the user interacts with the central server 1 to request song files, using a process which will be detailed in FIG. 2. Media devices 3 are apparatus to which the end user may and is allowed to copy the song file for his personal use. After downloading, the user is granted a license 4 for this specific song, and a copy of this license is recorded within the central server to protect the user from any lawsuit concerning this song.

A local ad server 1a is located inside the central server which contains advertising from companies doing business directly without calling on an advertising agency and which mostly has the same function as the ad agency server. The local song database contains all songs which an independent artist or a recording company wants to make available without calling on wholesalers. This database contains all information related to the songs, in terms of CD, type, songwriters, publisher, recording company and UPC code. It contains also the information for all songs from the external song database. All this information, essentially concerning copyright ownership has to be validated before the song is available for downloading. The management database 1b contains a database of users, their profile and certificates for all songs that they have downloaded, information about artists, recording companies, publishers, songwriters and mechanical licensee organizations.

This database 1b contains information and algorithms to calculate mechanical and production copyright which include artist royalties. This can be based on standard calculations, in terms of specific contract and major country copyright calculations. It also contains all information related to advertising terms of contract and algorithms of automated ad selection based on the geographical location of the user, standard or specific terms of contract and time frames.

This database will decide by using the financial requirement algorithm, how much advertising (n) has to be streamed, and how the song file is to be split into (n) parts, as well as deciding which advertising will be selected.

When the downloading process is completed, it generates the certificate and keeps it on record.

FIG. 2 is a detailed perspective of the technical and the flow process of the invention. When the user makes his login and his profile is established, 10, 11, 12, he makes a search for a specific song 13 by title, by artist, or by using the album title. Even with a typographic error, the search engine will compensate any error and will return a list of songs with similar spelling. When the user makes a choice of song and requests a download 14, the database management FIG. 1, 1b, decides how much advertising (n) has to be streamed to generate enough income to make the process profitable. It makes a choice and points to ‘n’ ads 17, divides the song file into ‘n’ parts, 15 starts downloading one of the split files, 21, and starts streaming ads and playing ads using a proprietary media player 19 which has no available controls except for minimizing the size of the window. During ad playbacks, the video portion of the ad will display on the full size of the browser screen and the user can't pause, stop, rewind, or fast forward the ads. At the end of the payback of the first online digital video commercial 20, the first split song file download is completed 22, the video player is required to display full size and on top 20 and pause at the last frame of the previous ad and an overlaid arrow is displayed and the user is prompted to click on it to resume the download. By clicking, it plays the next ads and downloads the next split parts of the song file. This process will continue until the last ad and the last split part of the song is downloaded. When this happens 26 the media player displays again on a full screen and on top status with an overlay of the last frame of the last ad. The user will get a thank you message and be prompted to click on an arrow to get the certificate of rights granted for this song. On clicking, the split files are re-assembled to restore a standard audio file in either WAV or MP3 29, and the certificate is displayed inviting the user to save it for proof of relative payment of duty for the download of this song 31.

A variant could involve displaying a grid of related ads containing information in each grid cell concerning sponsors and a hyperlink to their respective websites.

FIG. 3 is the business model underlying the process and this part constitutes the business invention. This figure represents mostly sections 7 and 8 of FIG. 1. FIG. 3 has two main parts; the left one: 40 to 44 and the right one: 45 to 48.

The first part of the figure represents compulsory dues required in to pay all copyrights related to the song. The amount of the copyright is divided in two parts. The first one 45 concerns mechanical rights, which is the right to reproduce the intellectual property. The mechanical rights, the amount of which we define as ‘X,’ belong to songwriters. The amount can be paid directly to the song writers, or to their publishers or to the collection corporation mandated by publishers for collection purposes, such as Harry Fox in the USA, CMRRA in Canada and BIEM in Europe. The amount may vary slightly based on country copyright laws. The other royalties are for people and corporations who make the song in a form that is commercially usable. The production copyright belongs to a recording company 47, and the artist royalty is for the main recording artist. Those royalties are added together and we designate this amount as ‘Y’ due to the fact that in practice, recording artists are usually under contract with a recording company, so this amount will be paid to the recording company, which will have to pay the artist royalties according to their contract. 48

The second part: 40 to 44 represents the money inflow process, which has to generate enough money defined as ‘W’ to cover all the copyright that has to be paid. This condition has to be considered automatically by the database management 1b which decides on the number and selection of ads to be streamed. The incoming amounts are based on the following formula: W=((c1+c2 . . . +cn)/(n*1000))*(d/l) where ‘ci’ (for i=1 to n) is the CPM rate allocated for the position of the ad in the streaming process, ‘d’ represents the total duration of all ads, ‘l’ represents the length of each ad, and ‘n’ the total number of consecutive ads. For example, 9 ads of CPM of 100 will generate $0.90 which is approximately the actual selling price for a song on internet for the time being.

To get a viable practical and useful business model ‘W’ has to be greater than X+Y, (49)

### CONCLUSION

Therefore, the reader will note that at least one embodiment of this invention is a more practical and more financial business model. In fact, a majority of people are used to watching commercials during TV programming, and we apply this habit to the world of internet, which places the user in a familiar situation. The user can use his digital file immediately. It's a onetime transaction. In fact it may be considered that we pay the viewer $0.99 for 3 minutes of his time for viewing purposes, which is quite fair to be legal and to respect copyright owners.

While the description above contains many specific points, these should not be construed as limitations on its scope, but rather as an example of one embodiment. For example we can add interactivity to the adds. At the end of the display of all ads when the user clicks to obtain the certificate, we can display in a table a list of all the advertisers who allow the user to obtain this song, and in each cell we can provide a link to this advertiser's website.

Accordingly, the scope should be determined not by the embodiment illustrated but by the appended claims and their legal equivalents.

### Glossary of Some Terms Specific to Advertising Based on Digital Video and Musical Industry

“Printing or impression process”: means for that specific industry a process to play a video advertising on TV or computer display, so it can be watched by an audience, and the number of printing or impression is the mean for accounting report for billing
“Companion ads”: Commonly text, displays ads, rich media, which goal is to offer sustained visibility of the sponsor, it may offer click-through interactivity and rich media experiences.

Rights granted for personal use: means that the user is granted a non-exclusive, non-transferable rights to use, copy, store, transfer and burn the Digital Content for personal, non-commercial, entertainment use.

1. a method of free downloading at least one digital music file in parallel of consecutive impression of a plurality of online digital video commercials over internet network, wherein this said impression of a plurality of online digital video commercials will generate an amount of money which is at least equal to or greater than the amount required to pay copyright owners, comprising:
a. providing said digital music file in a musical standard market format,
b. providing a means to control the completion of said downloading process of said digital music files so it starts approximately at the beginning of said impression of plurality of online digital video commercials, and finishes approximately at the end of the duration of this said impression of plurality of online digital video commercials,
c. providing said plurality of online digital video commercials which are mostly comprised of a plurality of different advertisement from at least one announcer,
d. providing a means to play these said plurality of online digital video commercials subsequently in a said consecutive manner characterized by the fact such that the user can't stop or cancel the printing process,
e. providing at least one internet server further including a digital music file database, a digital video commercial database, a user profile database and a data management process, connected to a user remote computerized device through said internet network.
f. providing a means to calculate automatically, the minimum number of ads comprising said plurality of online digital video commercials required to meet the financial requirement for copyright royalties
g. providing a means to select automatically the appropriate ads, according to and matching the announcers requirements and the user profile, which compose this said plurality of online digital video commercials specific for each download request.
Whereby said digital music file is given free of charge to said user, sponsored by a group of said announcers by the means of said printing of plurality of online digital video commercials for said copyright royalties clearance, and the user gets the certificate of personal use rights granted for the song by going through a onetime operation.

2. the method of claim 1 wherein said plurality of online digital video commercials composed of a group of linear video ads that takes over the full view of video window, the same way as for TV commercial

3. the method of claim 1 wherein said means to play online is a proprietary online media player characterized by the fact that when reaching the end of every said online digital video commercial it simultaneously pauses the video display and any downloading in process, further including the said full view of video window to be on top of windows, displaying the last video frame of the previous commercial, displaying a custom bitmap drawing on overlay, prompting the user to click the said bitmap for next step of the process, which simultaneously start the playback of the next commercial and resumes or starts the downloading process

4. the method of claim 1 wherein the downloading process include the step of dividing the digital music file in predetermined ‘n’ equal partial parts called fp1, fp2 . . . fpn, each said parts being sent to the user in a standard download process simultaneously with the printing of one of the said advertisements which is part of said plurality of online digital video commercials, in a such way that when said impression of plurality of online digital video commercials is over, all partial parts were sent to the user further including a process of re-assembling the parts to restore said digital music file

5. the method of claim 1 wherein the download process includes the steps of pre-evaluating the appropriate download speed to be used and allocated to make the ending of the printing and the downloading to coincide.

6. the method of claim 1 wherein clicking on the custom bitmap after the last digital online commercial activates the display of a grid of companion ads for all announcers sponsoring the download of this song.

7. the method of claim 1 wherein the minimum number of advertisements comprised in said online digital video commercials is obtained using the following formula
$$n = \frac{d}{l} > \frac{( x + y ) \times 1000}{\{ ( c 1 + c 2 + c 3 … + cn ) \} \div n}$$
where
n=minimum number of online digital video commercial required
l=average duration length of online digital video commercials
d=total time duration of all digital video commercial slot
x=amount for mechanical rights for author(s) and composer(s)
y=amount for production rights due to record company and recording artist
c1, c2, c3, . . . cn=CPM for each online digital video commercial depending on their ranking position during printing
